(19) United States
(12) Patent Application Publication
(10) Pub. No.: US 2014/0297321 A1
(43) Pub. Date: Oct. 2, 2014

(54) METHOD AND APPARATUS FOR MAPPING MESSAGE DATA

(71) Applicant: MCKESSON FINANCIAL HOLDINGS, Hamilton (BM)

(72) Inventor: Brian Adams, San Leandro, CA (US)

(73) Assignee: McKesson Financial Holdings, Hamilton (BM)

(21) Appl. No.: 13/854,061

(22) Filed: Mar. 30, 2013

(51) Int. Cl. G06F 19/00

(52) U.S. Cl. CPC G06F 19/322
USPC 705/3

(57) ABSTRACT

A method, apparatus and computer program product are therefore provided to determine a mapping between healthcare messaging protocols. This mapping may be generated by receiving a message containing a known set of data in an unknown format. The message may be analyzed to identify one or more data fields corresponding to the known data, and the data fields may be mapped to a known structure based on identification of the known data within the message. The process may be repeated until a mapping is generated for each field of the message. In some embodiments, the process may dynamically determine sets of known data to assist with identification of mapping between particular fields of the unknown format with fields of a known message format.

### TECHNOLOGICAL FIELD

Example embodiments of the present invention relates generally to health information systems, and, more particularly, to a method and apparatus for mapping healthcare message data.

### BACKGROUND

Advances in technology have led to the ability to access and share information more easily than ever before. It is increasingly common for individuals and companies to store their information in an electronic format, providing for easy sharing and archiving, and reducing the need for physical records. In particular, the ability to store medical records in an electronic format has the potential to revolutionize patient care by facilitating easy access to patient information among medical practitioners, users, healthcare organizations, and the like. However, the unique requirements for maintenance of electronic medical records have created challenges to implementation of electronic record storage and sharing systems.

One implementation of an electronic record storage and sharing system is the health information exchange. These exchanges provide for the ability to share a patient's medical records across the various health organizations and practitioner offices that participate in the exchange. Sharing of patient records in this manner allows for medical practitioners at a first institution to easily and efficiently determine what care and treatment the patient has received from other institutions. However, propagating records across multiple provider record systems may introduce new challenges. Although some standards have been established for the exchange of healthcare information, these standards allow for flexibility in the structure and format of messages and documents containing the healthcare information. One example format is the Health Level 7 International (HL7) healthcare messaging standard developed by the standards group of the same name.

Lack of a cohesive standard has resulted in many different implementations among healthcare software vendors. As such, communication between systems provided by vendors is difficult without knowing the particular message and record structure implemented by the vendor of the software generating the message. Experts may manually generate mapping programs that format input data in a first vendor's format to output data suitable for another vendor's format. Development of these mapping programs requires careful analysis of the form and structure of the structure of both the sending and receiving structure, such that generation of mapping programs is a laborious and time consuming task. As new messaging structures are implemented in response to standards revisions and product updates, new mapping programs must be generated to allow the new messaging structures to function with systems that implement alternative messaging structures.

### BRIEF SUMMARY

A method, apparatus and computer program product are therefore provided according to example embodiments of the present invention in order to provide for mapping of the structure healthcare messages using known healthcare data. In this regard, methods, apparatuses, and computer program products of example embodiments may operate to determine a mapping between healthcare messaging protocols. This mapping may be generated by receiving a message containing a known set of data in an unknown format. The message may be analyzed to identify one or more data fields corresponding to the known data, and the data fields may be mapped to a known structure based on identification of the known data within the message. The process may be repeated until a mapping is generated for each field of the message. In some embodiments, the process may dynamically determine sets of known data to assist with identification of mapping between particular fields of the unknown format with fields of a known message format.

Some example embodiments may include a method. The method may include receiving a first healthcare message in a first format. The first healthcare message may include a first set of known healthcare data comprising at least one healthcare data value. The method may also include determining a content of the first healthcare message and determining, using a processor, a first at least one data portion of the first healthcare message that corresponds to the at least one healthcare data value based on the content of the first healthcare message. The method may also include storing mapping data indicating that the first at least one data portion of the first healthcare message corresponds to the at least one healthcare data value.

Some example embodiments may include an apparatus. The apparatus may include processing circuitry. The processing circuitry may be configured to receive a first healthcare message in a first format. The first healthcare message may include a first set of known healthcare data comprising at least one healthcare data value. The processing circuitry may also be configured to determine a content of the first healthcare message, to determine a first at least one data portion of the first healthcare message that corresponds to the at least one healthcare data value based on the content of the first healthcare message, and to store mapping data indicating that the first at least one data portion of the first healthcare message corresponds to the at least one healthcare data value.

Some example embodiments may include a computer readable storage medium. The computer readable storage medium may include instructions that, when executed by a processor, configure the processor. The processor may be configured to receive a first healthcare message in a first format. The first healthcare message may include a first set of known healthcare data comprising at least one healthcare data value. The processor may be further configured to determine a content of the first healthcare message, to determine a first at least one data portion of the first healthcare message that corresponds to the at least one healthcare data value based on the content of the first healthcare message, and to store mapping data indicating that the first at least one data portion of the first healthcare message corresponds to the at least one healthcare data value.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a block diagram of an example of a network infrastructure in accordance with example embodiments of the present invention;

FIG. 3 is an illustration of a message data flow for mapping of an unknown message structure in accordance with example embodiments of the present invention;

FIG. 4 is an illustration of set of records in alternative formats in accordance with example embodiments of the present invention;

FIG. 5 is a flow diagram of an example of a method for implementing a message structure mapping system in a medical record system in accordance with example embodiments of the present invention; and

FIG. 6 is a flow diagram of an example of a method for providing known medical record data to facilitate a mapping operation in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in accordance with an example embodiment of the present invention in order to provide for mapping of message structures to facilitate the transfer of healthcare data. In this regard, a method, apparatus and computer program product of an example embodiment may receive one or more messages that include a set of known data in a first message format. The received messages may be analyzed to determine which fields of the message contain the known data. Upon identifying the presence of the known data, the fields of the message containing the known data may be mapped to a second message format. In this regard, fields of an unmapped message format may be mapped to facilitate mapping of messages received in the first format to a second format. Embodiments may further operate to determine additional sets of known data to map additional fields of the first format to the second format by sending the additional sets of known data and examining additional messages for the additional sets of known data.

For the purposes of this application, the term “healthcare message” should be understood to refer to at least any message or medical record provided in a format suitable for communication within a healthcare records system, such as a healthcare exchange. As such, the term “healthcare message” may include, but is not limited to, messages for transmission, modification, creation, or deletion of medical records (e.g., HL7 admit-discharge-transfer (ADT) messages), or any file or data format for storing of medical records or medical record data.

The term “record keeper” should be understood generally to refer to any individual or group that may request or provide access to patient healthcare data. This may include, but is not limited to, hospitals, physicians, patients, nurses, insurance companies, archives, government agencies, healthcare administrators, or any other provider, payer, or computer system maintained or operated by any of these entities. The term “record keeper” does not require or imply that the entity necessarily has record storage capabilities or will otherwise maintain any received records, although said entity may in fact possess such capabilities. Rather, this term is used merely to indicate the ability to participate in the exchange of patient healthcare data.

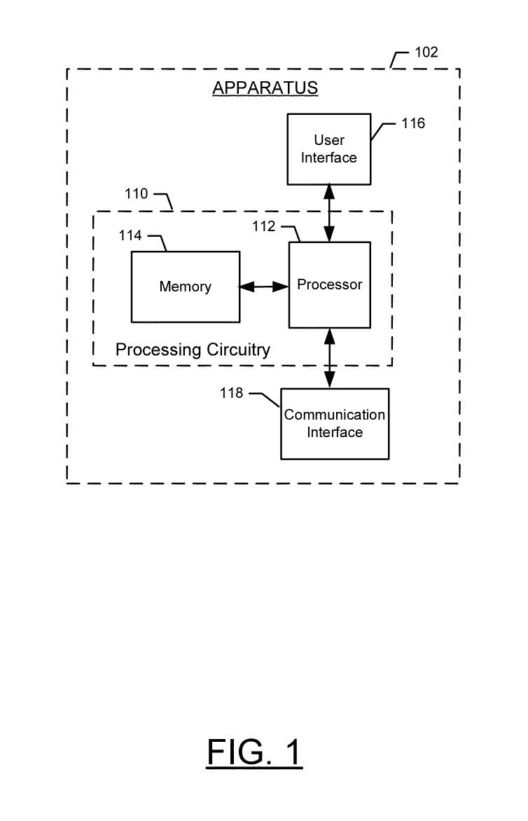

FIG. 1 illustrates a block diagram of an apparatus 102 in accordance with some example embodiments. The apparatus 102 may be any computing device capable of functioning in a health information infrastructure, including desktop or laptop computers, mobile devices, tablet computers, servers, or the like. In some particular embodiments, the apparatus 102 may be configured to provide access to patient healthcare data via a user portal. In some embodiments, the apparatus 102 may provide an interface for entry of medical records data via the user portal or another client application executing on the apparatus 102. For example, the apparatus 102 may be implemented on a computing device that may be configured to receive a patient identity, and to access and display records associated with the patient identity via a display. Additionally or alternatively, the apparatus 102 may be configured to provide a health information system operable to receive and process patient healthcare data queries as described herein. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

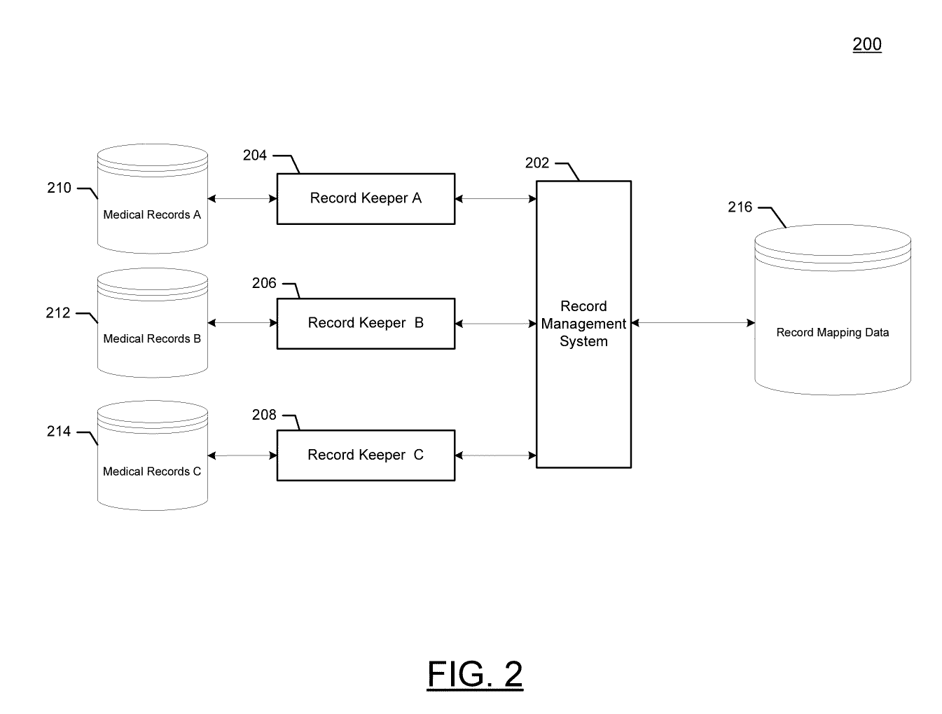

FIG. 2 is a block diagram of an example network infrastructure 200 in accordance with example embodiments of the present invention. The example network infrastructure 200 includes a record management system 202 in communication with one or more medical record keepers 204, 206, 208. The record management system 202 may function to implement searching, retrieval, and/or access to patient healthcare data maintained by the medical record keepers 204, 206, and 208. The record management system 202 may provide for propagation of healthcare data provided from a first one of the record keepers 204, 206, 208, to a second one or more of the record keepers 204, 206, 208. For example, the record management system 202 may be operable to publish received healthcare data to other record keepers that are in communication with the record management system 202. The record management system 202 may be embodied in one or more apparatuses, such as the apparatus 102 described with respect to FIG. 1.

The record management system 202 may function to provide an exchange of healthcare records data maintained by a plurality of medical record keepers. The example network infrastructure 200 depicts three medical client record systems, record keeper A 204, record keeper B 206, and record keeper C 208. For example, the record keepers may include healthcare organizations such as hospitals, physician's offices, medical imaging facilities, or the like. Record keepers may provide access to patient healthcare data to the record management system 202 and thus other record keepers for any particular reason in order to provide better access to data and clinical outcomes to patients, or for any other appropriate reason. The record management system 202 may thus provide an interface for publication, aggregation, and/or searching of patient healthcare data maintained by the associated record keepers. Although the example network infrastructure 200 depicts the patient healthcare data as maintained in separate datastores 210, 212, 214 associated with the individual record keepers 204, 206, 208, healthcare records may also be maintained in a central store accessible by the record management system 202, or in a cloud storage environment accessible to one or more of the record management system 202 or the record keepers 204, 206, 208. For example, although embodiments describe propagation to other record keepers, this propagation could include finalizing records stored locally to the record transfer system such that the finalized records are then accessible to the other record keepers.

The record keepers 204, 206, 208 may access the record management system 202 via a portal interface or application programming interface (API). For example, each record keeper may implement one or more applications for facilitating access to patient healthcare data. These applications may implement an API to send and receive requests for patient healthcare data to the record management system 202. Additionally or alternatively, the record management system 202 may provide direct access via a portal application (e.g., a web browser interface).

The record management system 202 may function to facilitate the publication, propagation, transfer, and/or conveyance of healthcare data across the record keepers 204, 206, 208. The record management system 202 may further provide for mapping of healthcare messages received from record keepers to alternative message formats. Each record keeper 204, 206, 208, may provide a different implementation for the healthcare messages. For example, a first healthcare record format may include separate fields for a patient first name and a patient last name, while a second record format may include a single field for the patient's first and last names. As another example, a first record format may implement a patient gender as a single bit, with a 0 value indicating male and a 1 value indicating female, while a second record format may use the ASCII character “m” for male and “f” for female. As yet another example, a first record format may include a string value for gender, with “male” and “female” as valid values, while a second record format may allow gender values for “male”, “female”, “male transgender”, and “female transgender”. As a further example, record formats may implement the same or substantially similar values for certain fields, but the fields may be presented in a different order.

As such, the record management system 202 may implement a mapping system to allow communication of healthcare messages received in a first format to record keepers that communicate via a different format. The mapping system may allow for dynamic derivation of these communications without the need for manually coded mapping applications, thus providing a dynamic, scalable system to enable communication across healthcare messaging format without requiring low level programming knowledge or intimate familiarity with particular message structures. In this manner, the record management system 202 may function to provide one or more sets of known data to a record keeper, so that the record keeper may generate a healthcare message which corresponds to the content of the known data. The record management system 202 may provide instructions to a client application executing on a client device used by the record keeper to prompt the creation of a record with particular contents. For example, the record management system 202 may direct a client application to create a record with a particular patient name, patient date of birth, patient gender, medical diagnosis, medical procedure code, practitioner notes, or the like.

The record management system 202 may direct creation of a healthcare message by the record keeper in an automated manner. For example, the record management system 202 may communicate with a user portal or other application executing on a client device operated by the record keeper to generate the message. Additionally or alternatively, the record management system 202 may communicate with a user of the client device to induce a user of the client device to enter particular known healthcare data. For example, the record management system 202 may generate one or more instructions to a user stating “Enter a patient name of ‘John Doe’”, “Enter a patient date of birth of ‘Oct. 6, 1982’” and the like. The record management system 202 may generate these instructions through a calibration application executing on the client device (e.g., an installation program executed by the user when configuring their medical record system to interface with the record management system), or via various alternative message techniques such as e-mail, short message service (SMS) messages, or the like. In some embodiments, the record management system 202 may communicate instructions to an administrator, and the administrator may verbally instruct the user of the client device as to what data should be entered for the known healthcare data. For example a user of the client record system may be instructed by the administrator to generate patient records using known data (e.g., fictitious records with values predetermined by the record management system) that may trigger the same or similar messages as would be observed during normal client workflows in the normal course of business (e.g., the same types of patient records normally created by the client). The record management system may record which data elements of the messages have been able to be uniquely identified by the record management system 202, and further instructions may be provided to instruct the user to perform additional workflows to process the entered known data or to add additional sets of known data to allow for unique identification of additional data elements.

Upon entry of the known healthcare data, the corresponding record keeper system may generate a healthcare message that is subsequently received by the record management system 202. The record management system 202 may analyze the healthcare message to identify the known healthcare data and map the locations of the known healthcare data in the message structure to a known message structure. For example, the healthcare message may be analyzed to map the location of the known healthcare data to, for example, a healthcare message format used by another record keeper, or to a universal healthcare message format.

As the record management system 202 identifies the locations of the known healthcare data in the healthcare messages, the record management system 202 may accumulate a set of record mapping data 216. The record mapping data 216 may identify the positions and formats of particular data fields within particular healthcare messages. For example, the record mapping data 216 may provide the particular bit locations, data types (e.g., string, floating point, integer), value lookups (e.g., “m” and “f”, or “male” and “female”, or “0” and “1” for a gender field), and the like that allow for determination of the contents of a healthcare message. This record mapping data 216 may be generated by examining the healthcare messages to determine how the known data is encoded in the particular healthcare message. In some embodiments, the record management system 202 may be aware of possible formats for various values of the set of known data. For example, the record management system 202 may search for particular strings or other sequences of data (e.g., ASCII character values, such as the string “male” or the character “m” when searching for the gender field) within the healthcare message that correspond to data provided in the known healthcare data.

In some embodiments, mapping data is identified based on changes between messages. For example, two sets of known healthcare data may be provided for generating two messages, with only a single value changed between the sets of known healthcare data (e.g., two sets of known data may be provided for the same patient name, birthdate, and medical condition, but different genders). By detecting which values of the received healthcare messages change across the two messages, the record management system 202 can pinpoint which portions of the message pertain to the changed value (e.g., by changing only the gender between two messages, the record management system can identify which portions of the message structure relate to the patient gender by determining which values have changed). In some embodiments, the record management system 202 may provide a particular set of messages that serve to identify a mapping for each field of the healthcare message. In some embodiments, the record management system 202 may dynamically determine a set of known healthcare data based on which fields of the healthcare message format have not been conclusively identified.

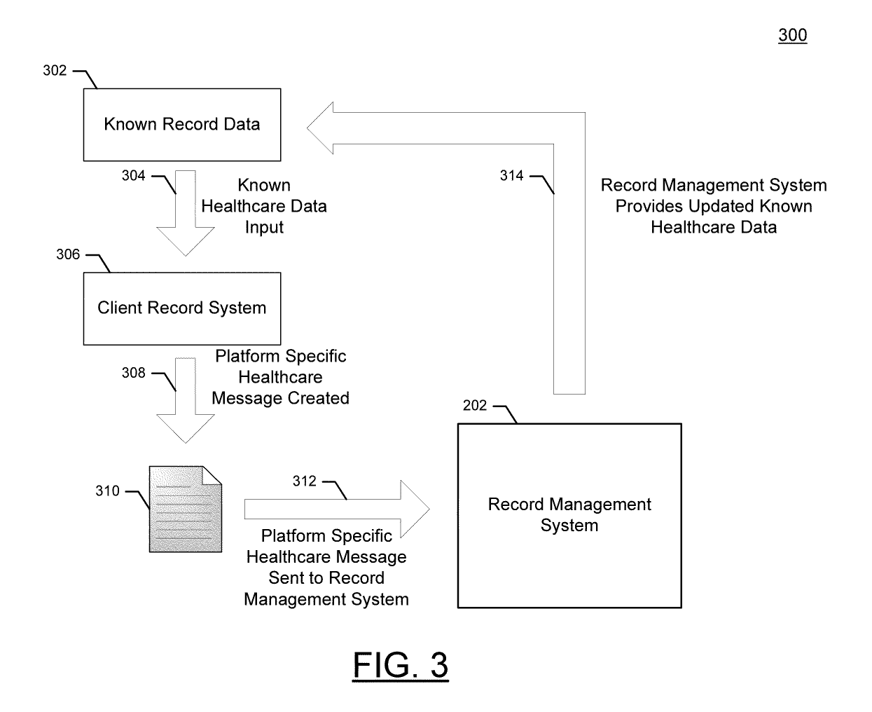

Examples of a message flow and methods for providing mapping of healthcare message data are described further below with respect to FIGS. 3-6.

FIG. 3 is an illustration of a message data flow 300 for mapping of an unknown message structure in accordance with example embodiments of the present invention. As described above, embodiments may provide for receiving a message with known content in an unknown messaging format, and analyzing the message to determine a mapping for the unknown messaging format to a known messaging format. The message data flow 300 describes how healthcare messages are generated with known content, received by a record management system, and analyzed to determine a mapping to a known format. The message data flow 300 further describes how the record management system 202 may generate instructions for providing additional known message content to generate additional healthcare messages to ensure that all fields of the unknown messaging format are properly mapped to a known messaging format.

At action 304, a set of known record data 302 is provided to a client record system 306. As described above, the client record system 306 may include a client record application executing on a client device for receiving patient healthcare data to generate healthcare messages. The known record data 302 may be provided by a record management system 202. For example, the record management system may prompt a user of a client device to enter particular data values in a medical record application, an administrator may provide verbal instructions to a user to enter particular values, a user may follow a set of written instructions, or the record management system 202 may cause the client device to execute programming instructions that cause the client device to populate a healthcare message with a known set of data.

At action 308, the client record system 306 generates a platform specific healthcare message 310 using the known record data 302. As described above, the platform specific healthcare message 310 may correspond to a particular record keeper, or to a particular software suite used by the record keeper. For example, different vendors may provide different implementations of HL7 healthcare messages that, while compliant with the HL7 standard, have unique structures and formats such that messages provided in a first format are not capable of communicating with a system requiring implementation in a second format, even if both formats are HL7 standard compliant. As another example, message structures may change based on software revisions of the client record system 306.

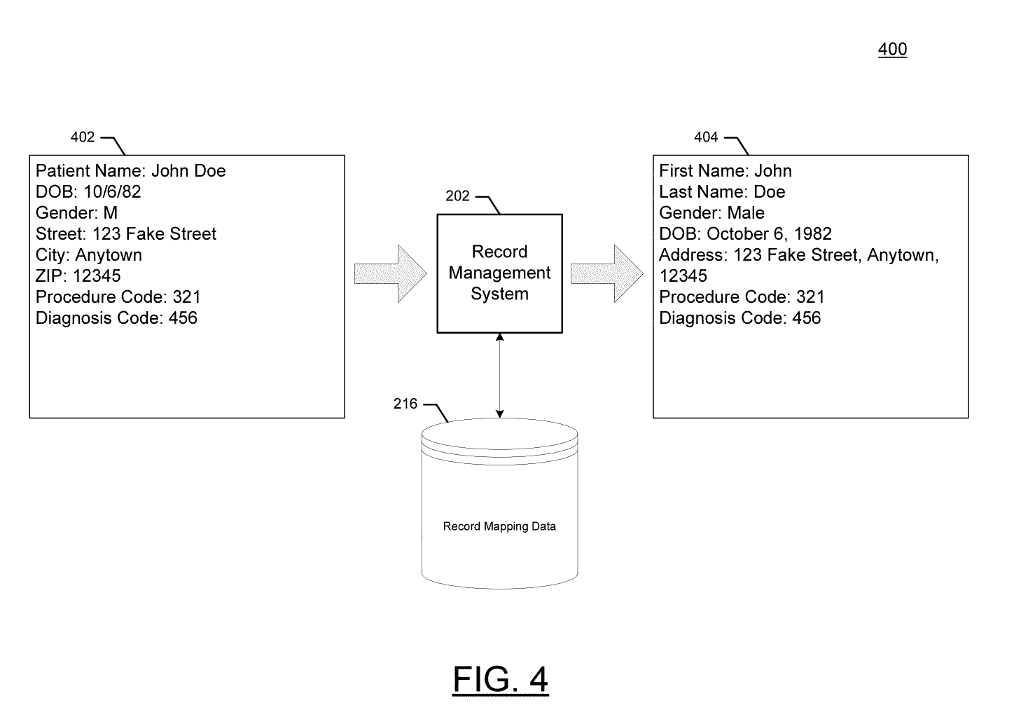

At action 312, the platform specific healthcare message 310 is sent to the record management system 202. As described above, the platform specific healthcare message 310 may be analyzed by the record management system 202 to identify the locations and formats of the known healthcare data within the platform specific healthcare message 310 as described above with respect to FIG. 2 and below with respect to FIGS. 4-6.

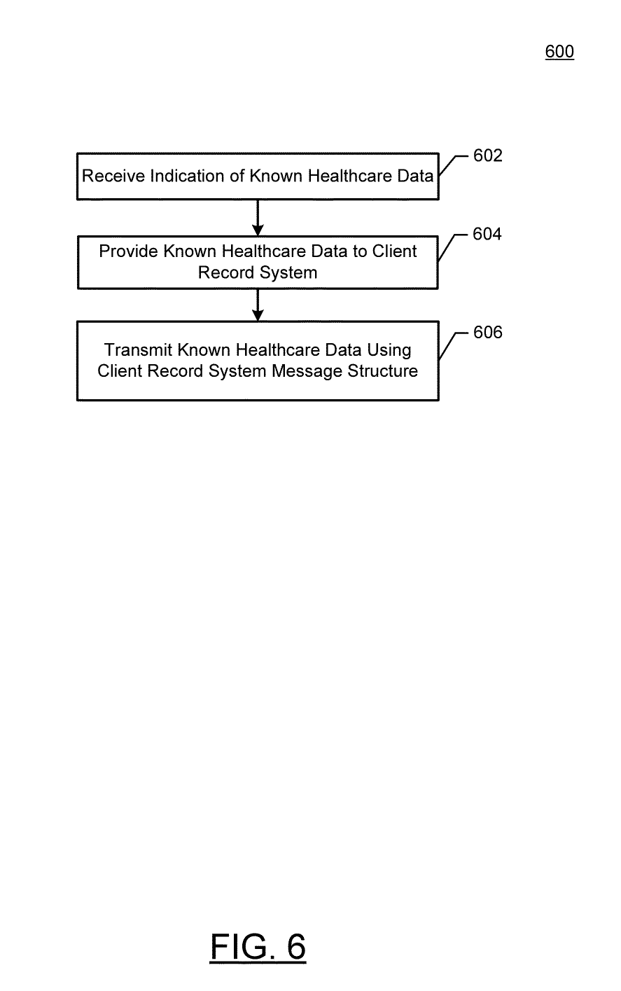

At action 314, the record management system 202 may provide another set of known healthcare data for use in generating a new healthcare message. For example, the record management system 202 may alter a patient name, date of birth, or gender so as to derive additional data for use in the mapping process. An example of a method for receiving a set of known healthcare data and generating a healthcare message is described further below with respect to FIG. 6.

FIG. 4 is an illustration of set of records 400 in alternative formats in accordance with example embodiments of the present invention. As described above, the mapping operation may have the end result of generating a set of mapping data that operates to allow healthcare messages provided in a first format to record keeper systems designed to communicate in a second format. The set of records 400 illustrates how the mapping process is operable to convert healthcare messages in this manner.

The set of records 400 includes a record in a first format 402 and a record in a second format 404. As can be readily discerned from the Figure, both records 402 and 404 contain the same healthcare data, but each record provides the data in a different format. For example, the first record 402 contains a single field for the patient name, “John Doe”, while the second record 404 contains two fields, one for the patient first name, “John”, and one for the last name, “Doe”. Similarly, the patient gender is represented as a character value “M” in the first record 402, and the string “Male” in the second record 404. As should be readily appreciated from the discussion herein, the values and formats of these records used for the mapping operation may not only pertain to the data displayed when viewing the record, but also the actual data storage format and encoding of the data. For example, although text values provided in Unicode and ASCII may both be visible as text when viewed with a viewer application, the two text encoding formats may not be readily transferrable between record keepers if the record keeper expects the text to be encoded in the alternative format. In the present example, the record management system 202 uses the set of record mapping data 216 to effect the mapping of a record from the first format 402 to the second format 404.

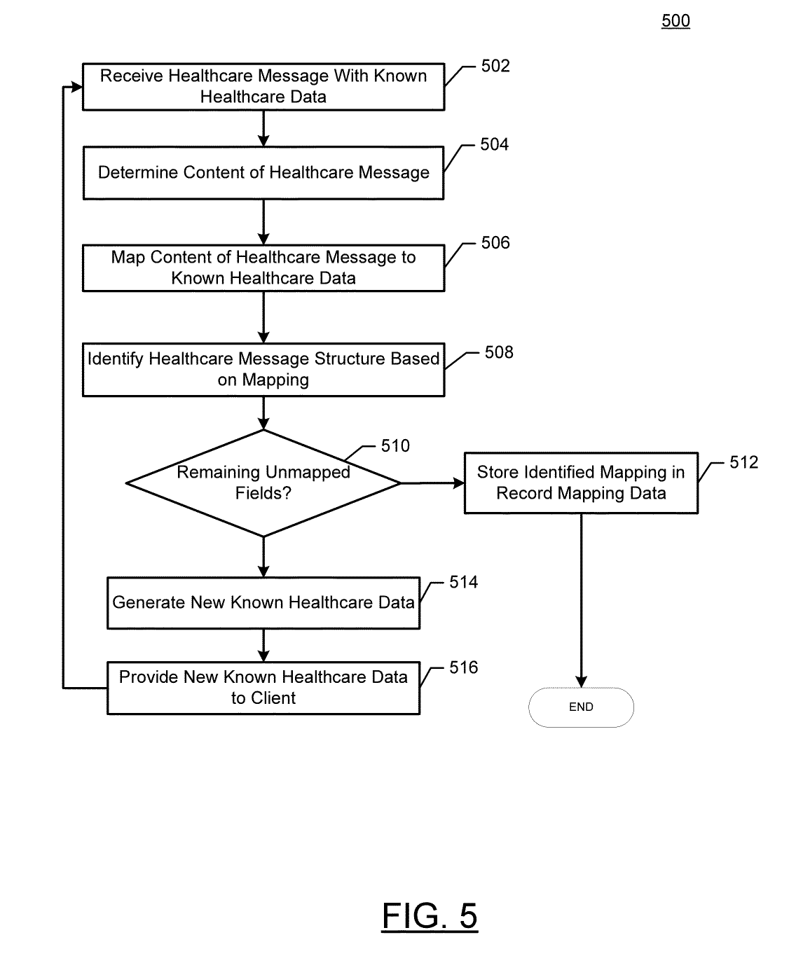

FIG. 5 is a flow diagram of an example of a method 500 for implementing a healthcare message structure mapping system in a medical record system in accordance with example embodiments of the present invention. The method 500 is operable to identify the structure and format of a healthcare message based on detecting the location and known healthcare data within the contents of the healthcare message. The method 500 may be performed by a record management system, such as the record management system 202 described above with respect to FIGS. 2 and 3. The method 500 may also be performed by one or more apparatuses, such as the apparatus 102 described with respect to FIG. 1.

At action 502, a healthcare message containing a set of known healthcare data is received. In some embodiments, the healthcare message may be known to include a set of known healthcare data by virtue of the fact that a record management system has begun a mapping process. For example, the record management system may initiate a mapping operation when a record keeper system is first configured to communicate with the record management system. When a user of a client device is first being configured to communicate with the record management system, the client device may send a notification to the record management system to begin the mapping process. The record management system may thus provide instructions to a client to generate the healthcare message containing the set of known healthcare data. A method for generating the healthcare message with the set of known healthcare data is described further below with respect to FIG. 6.

At action 504, the content of the healthcare message is determined. As described above, healthcare messages may be provided in various formats, and the record management system may not be aware of the particular format prior to performing the mapping operation. As such, the record management system may examine the data contained within the healthcare message (e.g., the values of one or more bits within the message data structure).

At action 506, the contents of the healthcare message are mapped to the values of the known healthcare data. Mapping of the contents may include comparing the contents of the healthcare message with different format possibilities for different fields of the healthcare message. For example, as described above, a patient date of birth may be represented as a string (e.g., “Oct. 6, 1982”), a slash delimited date value with a 2 digit year (e.g., “10/6/82”), a slash delimited date value with a 4 digit year (e.g., “Oct. 6, 1982”), a double value representing a number of seconds since an epoch (e.g., “402727875”) or any other format. In some embodiments, the record management system 202 may be aware of one or more of these possible formats, and the contents of the healthcare message may be parsed to identify possible locations for the respective fields of the data. For example, the healthcare message might be parsed for bit values that correspond to the different methods of storing the date as described above, and bit values that match possible implementations of the date may be marked as possibly containing the date field of the message.

At action 508, elements of the message structure may be identified based on the mapping. As portions of the healthcare message are identified as possibly containing particular portions of the set of known data, the method 500 may determine a likelihood that the portions of the healthcare message correspond to the particular field of the set of known data. For example, if a particular set of bit values are the only set of bit values within the healthcare message that correspond to a possible structure of provided known data, then the set of bit values may be marked as highly likely to correspond to the field of the known data. For example, if a date of birth of “Oct. 6, 1982” was known to be contained within the set of known data, and only one set of bit values corresponds to one of the date formats enumerated above, then that set of bit values may be marked as likely to relate to the date field of the healthcare message. In some embodiments, multiple sets of bit values may be identified within the healthcare message as possible candidates for a particular data field, and multiple iterations may be employed to confirm which bit values correspond to the data field. In some embodiments, mapping of particular bit values to particular data fields may be confirmed if the likelihood of a match rises above a particular threshold value. Various methods may be employed for calculating the likelihood of a match, including but not limited to determining how many possible sets of bit values pertain to the field of the set of known data, how many remaining unmapped values from the set of known data remain, how many bit values of the healthcare message remain unmapped to the set of known data, and various additional or alternative implementations and combinations thereof. In some embodiments, different weights are applied to different factors to calculate the likelihood.

At action 510, a determination is made as to whether unmapped fields remain. For example, the method may determine whether a mapping with a reasonably high level of confidence has been determined for each possible type of data to be included in various healthcare messages. If the method determines that the mapping is complete, the method proceeds to action 512. If a mapping has not been conclusively established, then the method may proceed to action 514.

At action 514, a new set of known healthcare data is generated. The new set of known healthcare data may correspond to the remaining unmapped fields. For example, if the location of a gender field within the healthcare message is unknown, then the method may generate a set of known data that corresponds to a set of previously provided known healthcare data, but with the gender field changed to an alternative value. As such, when a new message is received, the set of known data may be examined to identify which value has changed. Since the only value that changed in the set of known data was the gender, it may be possible to identify the changed value as related to the gender field.

In some embodiments, generating a new set of known healthcare data may include providing a next set of healthcare data in a sequence of sets of known healthcare data. For example, the method may include a set of known data that, when examined, provides sufficient combinations and permutations of known values to be sufficient to establish with a high degree of specificity which portions of the healthcare message pertain to which fields of the known data.

At action 516, the new set of known data is provided to the client for use in generation of a new healthcare message. For example, the new set of known healthcare data may be communicated to the client via an installation or configuration application executing on the client device. Additionally or alternatively, a user of the client may be provided with instructions for entering the new set of known healthcare data, such as via an e-mail, text message, or voice communication. In some embodiments, the user may not be directed prompted to enter the new set of known data. Instead, the user may be provided with a procedure instructing the user to enter particular values in a particular order. For example, the user may be provided with several sets of known healthcare data and instructed to enter the sets of known healthcare data in sequence upon initialization of a client records system. In some embodiments, a sequence of sets of known healthcare data may be automatically transmitted to the records management system as part of an initialization function, without requiring manual entry of the sets of known healthcare data by the user. After providing the new set of known data to the client, the method may return to action 502 to repeat the process until the mapping process is complete.

At action 512, the identified mapping data is stored. For example, the mapping data may include an identification of particular portions of a message that relate to particular data fields, for use in future interpretation of messages received in that format. The mapping data may also include an identifier of from which record keeper the message was received, in case the message does not specify a unique format identifier. For example, a particular record keeper may be identified as providing messages with a particular structure, and all messages received from that record keeper may have a mapping operation applied based on a mapping process performed during initialization. The method 500 may end after storing the mapping data.

FIG. 6 is a flow diagram of an example of a method 600 for providing known healthcare data to facilitate a mapping operation in accordance with example embodiments of the present invention. The method 600 is operable to generate healthcare messages that contain known healthcare data for use in a mapping operation. The method 600 may be performed by a client device in communication with a record management system. The method 500 may also be performed by one or more apparatuses, such as the apparatus 102 described with respect to FIG. 1.

At action 602, an indication of a set of known healthcare data is received. As described above, the known healthcare data may be received via a variety of communication mechanisms, including but not limited to a network message received by a client application, by a display generated by an installation application, by an administrator in verbal contact with a user, by an automated process whereby the record management system communicates directly with a client records system, by an e-mail, by a user manual, or the like. In some embodiments, the set of known healthcare data may be received as part of a sequence of sets of healthcare data designed to result in transmission of several healthcare messages that together establish a mapping of the structure within the healthcare message to the set of known data.

At action 604, the known healthcare data is provided to a client record system. For example, as described above, the known healthcare data may be entered by a user into a client record system, or the known healthcare data may be provided to the client record system in an automated manner via electronic communication. At action 606, the known healthcare data is provided to the records management system for use in a record mapping operation as described above.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a first healthcare message in a first format, the first healthcare message comprising a first set of known healthcare data comprising at least one healthcare data value;
determining a content of the first healthcare message;
determining, using a processor, a first at least one data portion of the first healthcare message that corresponds to the at least one healthcare data value based on the content of the first healthcare message; and
storing mapping data indicating that the first at least one data portion of the first healthcare message corresponds to the at least one healthcare data value.

2. The method of claim 1, further comprising:
receiving another healthcare message in the first format; and
using the mapping data to convert the another healthcare message to a second format.

3. The method of claim 1, further comprising providing the first set of known healthcare data to a client.

4. The method of claim 3, wherein the first healthcare message is received from the client.

5. The method of claim 3, wherein the first set of known healthcare data is provided to the client via an installation application.

6. The method of claim 1, further comprising:
generating a second set of known healthcare data comprising a second at least one healthcare data value; and
providing the second set of known healthcare data to a client for use in generating a second healthcare message.

7. The method of claim 6, further comprising:
determining that a second at least one portion of the healthcare message remains unmapped; and wherein the second at least one healthcare data value is determined based on the unmapped second portion of the healthcare message.

8. The method of claim 1, further comprising:
determining a confidence value that the first data portion of the first healthcare message corresponds to the at least one healthcare data value; and
storing the mapping data in response to determining that the confidence value is greater than a threshold value.

9. The method of claim 8, wherein the confidence value is determined based on at least one of a number of unmapped portions of the first healthcare message or a number of possible portions to which the at least one healthcare data value matches.

10. The method of claim 1, further comprising comparing the content of the first healthcare message to a plurality of possible data formats for the at least one healthcare data value to determine the first at least one portion of the healthcare message.

11. The method of claim 1, wherein the possible data formats comprise at least one of a floating point value, a string value, a character value, or a date value.

12. An apparatus comprising processing circuitry configured to:
receive a first healthcare message in a first format, the first healthcare message comprising a first set of known healthcare data comprising at least one healthcare data value;
determine a content of the first healthcare message;
determine a first at least one data portion of the first healthcare message that corresponds to the at least one healthcare data value based on the content of the first healthcare message; and
store mapping data indicating that the first at least one data portion of the first healthcare message corresponds to the at least one healthcare data value.

13. The apparatus of claim 12, further configured to:
receive another healthcare message in the first format; and
use the mapping data to convert the another healthcare message to a second format.

14. The apparatus of claim 1, further configured to provide the first set of known healthcare data to a client.

15. The apparatus of claim 14, wherein the first healthcare message is received from the client.

16. The apparatus of claim 14, wherein the first set of known healthcare data is provided to the client via an installation application.

17. The apparatus of claim 12, further configured to:
generate a second set of known healthcare data comprising a second at least one healthcare data value; and
provide the second set of known healthcare data to a client for use in generating a second healthcare message.

18. A computer readable storage medium comprising instructions that, when executed by a processor, cause the processor to:
receive a first healthcare message in a first format, the first healthcare message comprising a first set of known healthcare data comprising at least one healthcare data value;
determine a content of the first healthcare message;
determine a first at least one data portion of the first healthcare message that corresponds to the at least one healthcare data value based on the content of the first healthcare message; and
store mapping data indicating that the first at least one data portion of the first healthcare message corresponds to the at least one healthcare data value.

19. The computer readable storage medium of claim 18, further comprising instructions that cause the processor to:
receive another healthcare message in the first format; and
use the mapping data to convert the another healthcare message to a second format.

20. The computer readable storage medium of claim 18, further comprising instructions that cause the processor to provide the first set of known healthcare data to a client.
